(19) United States
(12) Patent Application Publication
(10) Pub. No.: US 2016/0239840 A1
(43) Pub. Date: Aug. 18, 2016

(54) SYSTEM AND METHOD OF SECURELY TRANSFERRING PAYMENT FOR AN ONLINE TRANSACTION

(71) Applicant: CA, Inc., New York, NY (US)

(72) Inventor: Sascha Preibisch, Richmond (CA)

(73) Assignee: CA, Inc., New York, NY (US)

(21) Appl. No.: 14/624,081

(22) Filed: Feb. 17, 2015

(51) Int. Cl. G06Q 20/40; G06Q 20/38

(52) U.S. Cl. CPC G06Q 20/405; G06Q 20/3829

(57) ABSTRACT

The system and method of the present disclosure relates to securing financial data associated with an online payment made over a network at a merchant website, without sharing financial details with the merchant. Merchants register with financial institutions of their customers in order to form a trusted and secure relationship. When a customer purchases an item at the merchant website, a payment option is presented to the customer on the merchant website. The customer is then redirected to a website of the financial institution to authenticate the payment. Once the payment is authenticated, the financial institution may pay the merchant using a secure connection. The customer may also grant the merchant permission to share consumer profile information. Thus, when the consumer shops online at the merchant website, payment may be made to the online merchant directly from the financial institution of the consumer without having to share any financial details.

### BACKGROUND

The buying and selling of products and services over a network, such as the Internet, has increasingly become a means by which consumers shop. As the buying and selling or products and services online continues to grow, the number of electronic payment transactions also increases. In a typical online transaction (i.e., an ecommerce transaction), the sale and purchase is completed online and in real time. For example, if an online merchant sells a book to a consumer shopping online, the book is also paid for by the consumer at the time of the sale. In such a case, most online payments involve the use of a credit card, debit card or a third-party payment service provider, such as PayPal™.

Online payments, using for example a credit card, require financial details relating to the credit card to be transmitted over the Internet, to a merchant, merchant bank, service provider, consumer bank, and a credit card company and in many instances numerous other entities. The information may include private information such as the credit card account number and the expiration date, all of which is necessary information to complete an online transaction using a card holder's account. Once the credit card information has been submitted as part of the online transaction, the payment details may be obtained by any of the parties involved in the transaction which may lead to invalid or fraudulent charges on the cardholder's account. Currently, encryption technology can make it difficult for unauthorized parties to access the information. However, once the information is stored in an unencrypted format, the information may become available to employees and the like. Moreover, techniques may be applied to the encrypted information to gain access. And, while theft and fraudulent use of another's credit card has some protections under the law in the United States, other jurisdictions do not offer such protections. It therefore becomes paramount to limit the number of parties or entities involved in such an online transaction such that the percentage of unauthorized behavior is reduced (i.e., online transactions become more secure).

### BRIEF SUMMARY

The present disclosure, generally described, relates to technology for securing the transfer of payments made during an online transaction over a network, and in particular, to securing financial data associated with an online payment made at a merchant website without sharing financial details.

More specifically, the present disclosure relates to a secure payment system and method for processing an online transaction made by a consumer at a merchant website. To secure the transaction, and particularly the financial information and details related to payment, financial data and profile information of the consumer are stored at a financial institution having a relationship with the consumer. For example, a consumer with an account at the financial institution has financial data and profile information stored therein. Merchants register with the same financial institution as the consumer in order to form a trusted and secure relationship that will enable financial transactions without having to share sensitive financial data. When the consumer purchases products or servers at the merchant website, a payment option is presented to the consumer on the merchant website. After selecting a form of payment, the consumer is redirected to a website of the financial institution associated with the payment option to authenticate the payment. For example, if the consumer selects the option to pay by credit card, then the consumer is redirected to a login page of the credit card website for which she has an account. Once the payment has been authorized by the consumer, the financial institution may issue payment to the merchant upon completion of the online transaction (e.g., after the purchased products are shipped or services garnered). Additionally, the consumer may grant the merchant, via the financial institution, permission to share consumer profile information, such as shipping and billing address. Thus, when the consumer shops online at the merchant website, payment may be made to the online merchant directly from the financial institution of the consumer without having to share any financial details with the merchant. That is, access to the financial details may be restricted using, for example, restriction access data that is governed by rules or a set of rules. Moreover, since consumers may be registered with more than one financial institution, no single party stores all of the consumer's financial information, thereby providing a decentralized storage system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures with like references indicating like elements.

FIG. 1 is an exemplary system of a network to secure the transfer of financial data during an online transaction.

FIG. 2 is an exemplary diagram of a process flow to secure the transfer of financial data during an online transaction.

FIG. 3 is an exemplary block diagram of a public key infrastructure for use with the system and process of FIGS. 1 and 2.

FIG. 4 is an exemplary block diagram of an open standard to authorization for use with the system and process of FIGS. 1 and 2.

FIG. 5 is an exemplary block diagram of an authorization layer framework for use with the open standard of FIG. 4.

FIG. 6 is an exemplary block diagram of an open standard format used to transmit data objects as a web token for use with the system and process of FIGS. 1 and 2.

FIG. 7 is an exemplary flowchart illustrating an embodiment of a merchant registering with a financial institution in accordance with the system and process of FIGS. 1 and 2.

FIG. 8 is another exemplary flowchart illustrating an embodiment of a merchant registering with a financial institution in accordance with the system and process of FIGS. 1 and 2.

FIG. 9 is an exemplary flowchart illustrating the process of securing the transfer of payment for an online transaction in accordance with the system of FIG. 1.

FIG. 10 is an exemplary flowchart illustrating the denial of a request for payment of an online transaction in accordance with FIG. 9.

FIG. 11 is an exemplary flowchart of payment authorization for a payment made during an online transaction in accordance with FIG. 9.

FIG. 12 is another exemplary flowchart of payment authorization for a payment made during an online transaction in accordance with FIG. 9.

FIG. 13 is an exemplary flowchart of processing payment made during an online transaction in accordance with FIG. 9.

FIG. 14 is an exemplary flowchart illustrating another process of securing the transfer of payment for an online transaction in accordance with the system of FIG. 1.

FIG. 15 is an exemplary flowchart of shopping and payment selection in accordance with FIG. 14.

FIG. 16 is an exemplary flowchart of a login process for payment during an online transaction in accordance with FIGS. 2 and 14.

FIG. 17 shows an exemplary general computer system that may be used to implement the system and process depicted in FIGS. 1, 2, 9 and 14.

### DETAILED DESCRIPTION

The present disclosure, generally described, relates to technology for securing the transfer of payments made during an online transaction over a network, and in particular, to securing financial data associated with an online payment made at a merchant website without sharing financial details. More specifically, the system and method of securing the transfer of financial data in a network includes the use of secure connections established between a merchant, consumer and financial institution such that payment may be effected between the merchant and financial institution without having to share the consumer financial details with the merchant. After the merchant has registered with the financial institution, a payment request is made to the financial institution in response to an online transaction made at a website of the merchant by the consumer. The payment request causes the merchant website to redirect the consumer to a website of the financial institution and prompts the consumer to authenticate the payment by providing login credentials to access an associated account. Upon authorizing the merchant for payment, details of the online transaction (e.g., payment amount, etc.) are conveyed to the financial institution, and a trusted relationship is established between the financial institution and the merchant. Payment for the online transaction may then be made by the financial institution using a mutually secure connection in which the financial details are not provided to the merchant.

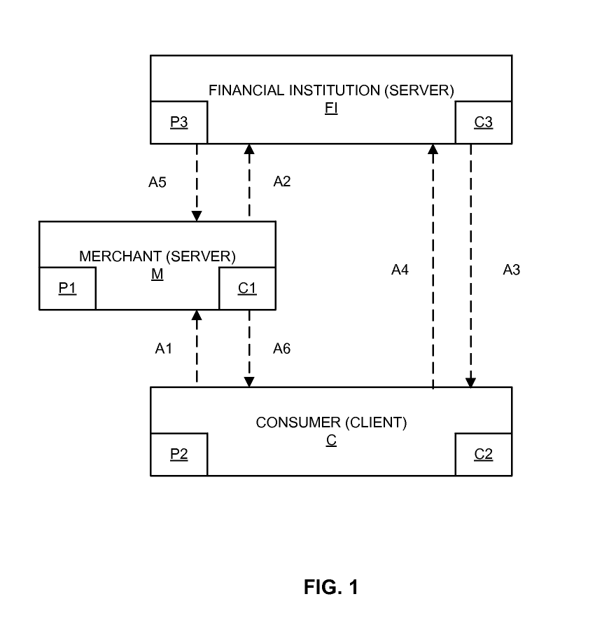

FIG. 1 is an exemplary system of a network to secure the transfer of financial data during an online transaction. The exemplary system of FIG. 1 includes a network having a financial institution FI (such as a server), a merchant M (such as a server) and a consumer C (such as a client computer). The financial institution FI also has a storage S (or storage system) communicatively coupled thereto for storing financial and consumer information and data, a receiver R to receive communication for the merchant M, an authenticator AR to authenticate a consumer C, and an authorizer ATH to authorize payment and consumer profile information (discussed in more detail below). As appreciated, each of the components in the financial institution FI may comprise hardware, software or any combination thereof. As illustrated, the merchant M (or merchant server M) is operatively connected across a network (not shown) to one or more consumers C (or customer computer or client server) and one or more financial institutions FI (or financial institution server FIs). The merchant M includes, for example, a communication device C1 configured for communicating across the network with the consumer C and the financial institution FI. The merchant may also include one or more processors P1 to control the communication device. The consumer C may also include a communication device C2 (e.g. Ethernet card, wireless interface, etc.) configured to communicate with the merchant M and the financial institution FI. The consumer also includes one or more processors P2 configured to control the communication device and to read and execute a web browser displayed at the consumer C for navigating the network, such as, for example, visiting web pages via the Internet. In one embodiment, for example, the web browser allows the consumer C to visit a website of the merchant M. The financial institution FI may also include a communication device C3 configured to communicate over the network with the consumer C and the merchant M. The financial institution FI also includes one or more processors P3 configured to control the communication. The storage S may store any form of information or data, including financial data, access restriction data and rules or rule sets governing the access restriction data. It is appreciated that the access restriction data and rules (or rule sets) may be any type or data or rules associated with access restriction, as well known in the art.

Although the depicted system shows a single financial institution FI, merchant M and consumer C, it is appreciated that any number of financial institutions, merchants and consumers may exits and that the simplistic embodiment depicted in FIG. 1 is for ease of discussion. In the disclosed embodiment, a decentralized online payment system is provided in which transactions (e.g., purchase of an item on the Internet) may occur without sharing or restricting access of consumer financial information or data (e.g., credit card information) and/or details (e.g., shipping and billing address) with any party (e.g. merchant, acquirer, PSP, etc.) other than the financial institution FI associated with the consumer C (e.g., the consumer credit card company and/or issuing bank). Within the context of this disclosure, decentralization refers to a consumer's financial information being known and stored with disparate financial entities, each having an existing relationship with the consumer C. Thus, in the contemplated system, when a consumer purchases, for example, an item with an online merchant, the merchant M (or any other party that is not the financial institution FI) is not privy to the consumer's financial information, other than an indication of the form of payment (e.g., credit card, debit card, etc.). Significantly, this results in fewer parties having or gaining access to the consumer's financial information, thereby providing an added level of security to data that is inherently private. The consumer C also has the option to allow (grant) or deny consumer profile information (e.g., billing address, shipping address, contact information, etc.) to be sent from the financial institution FI to the merchant M.

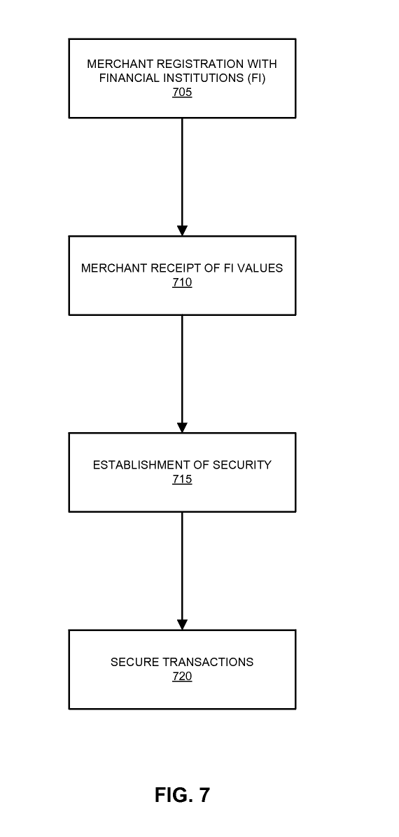

The system and processes described herein may be used for or within various online or electronic commerce (e-commerce) systems, sub-systems, and/or components. With continued reference to FIG. 1, there is shown one embodiment of a secure payment system that may comprise a plurality of system entities in communication with each other through a network (not illustrated). The system, which in one embodiment is a payment system, depicts a merchant M, such as but not limited to a merchant company, merchant server, merchant processor or merchant website, in communication with the consumer C, such as but not limited to a purchaser, buyer, client device, client server, client processor, etc., and a financial institution FI, such as but not limited to a financial company, bank, financial server, financial processor, etc. The merchant M may communicate directly with the consumer C (A1/A6), for example to transact with the consumer C on the merchant website, and communicate directly with the financial institution FI (A2/A5), for example to request payment for the transaction with the consumer C. For example, the merchant M may be an online retail website that requests payment from the financial institution FI for an online transaction made by the consumer C. The financial institution FI, in response to the request, submits the requested payment on behalf of the consumer C to the merchant M, after proper authorization (discussed below). Also depicted is a direct communication between the consumer C and the financial institution FI (A3/A4). Notably, the financial institution FI is associated with the consumer C. That is, the financial institution FI has an existing financial relationship with the consumer C, such as but not limited to a bank account, debit card account, investment account or credit card account. In order for the merchant M to request payment for any transaction conducted by the consumer C on the merchant retail website, the merchant M must also have a financial relationship with the financial institution FI of the consumer C. That is, the merchant M must first register and establish an account with the financial institution FI. Moreover, any financial transaction with the merchant M from the financial institution FI should be approved in advance by the consumer C prior to payment of any monies or transmittal of any consumer information. A discussion of the merchant registration process with the financial institution is described below with reference to FIG. 7.

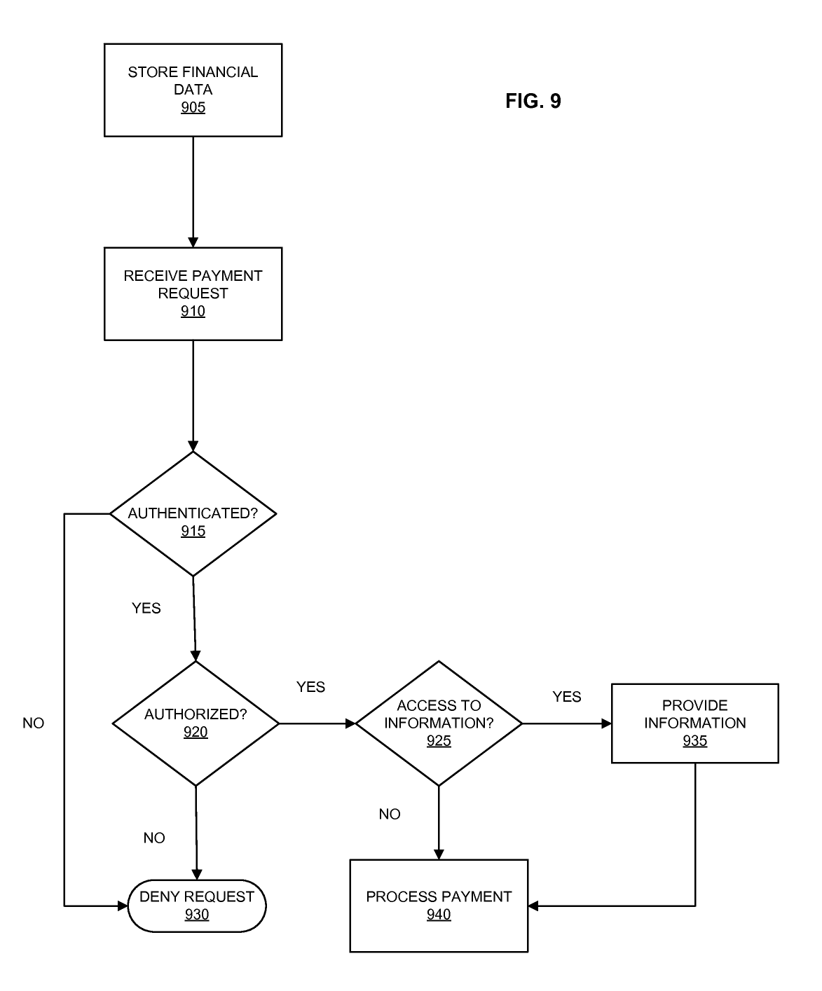

An exemplary high-level process flow for payment over the system illustrated in FIG. 1 follows. The consumer C (also termed purchaser or buyer) accesses an online website of the merchant M. The consumer C may also be a client device, such as a computer, mobile device, processor, etc. The consumer C may visit an online store of a merchant, such as Amazon™ or eBay™, to purchase items or services. Once the consumer C has selected items on the merchant website for purchase, the items are placed in a shopping cart for checkout. At checkout, the consumer C is presented with payment options (i.e., different forms of payment) such as credit card, debit card, etc. In the following example, the payment process begins when the consumer C selects a form of payment to purchase the item(s) in the shopping cart from the merchant M at A1. At A2, the merchant M requests payment from the financial institution FI that has a financial relationship with the consumer C. In response to the merchant M request for payment, the financial institution FI requests consent from the consumer C to pay the merchant M for the transaction, at A3, without providing any financial details to the merchant M. The consumer C may then grant or deny access of the payment request at A4. If the buyer denies the payment request, then the transaction ends and the financial institution FI does not pay the merchant M for the requested payment (and the transaction is terminated). If, on the other hand, payment is granted by the consumer C at A4, then the merchant M is informed about the payment being granted by the financial institution FI at A5, and the merchant executes the transaction by shipping the purchased item(s) to the consumer C. The merchant M then receives payment from the financial institution FI. A more thorough description of the transaction process implemented on the system will be described below with reference to FIGS. 9-15.

It is appreciated, that during the payment portion of the online transaction, the consumer C is requested to enter financial information directly with the issuing financial institution FI. That is, when the consumer C completes the payment process with merchant M, she is redirected to a website of the financial institution FI for authorizing and verifying payment associated with the transaction (i.e., in one embodiment, the consumer may be redirected to the financial institution in a transparent manner). Redirecting the consumer C to the website of the financial institution FI provides an effective mechanism to prevent the merchant M (and others) from having access to the consumer financial information. That is, handing off payment processing to the financial institution FI serves to avoid potential fraud and misuse of such private information. Additionally, the consumer C is able to retain the option of providing profile information, such a billing a shipping address information, to the merchant M through the financial institution FI. Moreover, since consumers C and merchants M do not all use the same financial institution FI (i.e., they register with different financial institutions) or may register with more than one financial institution FI, the system of FIG. 1 also acts to store information in a decentralized manner. For example, if a consumer C has account A with financial institution A and account B with financial institution B, any financial information (or profile information) about the consumer C will be stored at different locations (e.g., account A information will be stored with financial institution A, and account B information will be stored with financial institution B) in a decentralized manner (i.e., the data is not stored at a central location). It is appreciated that the information may also be stored in a centralized manner, although the level of security may be degraded. Moreover, consumer financial information details may also be stored at each of the separate institutions to assist in avoiding fraud and misuse of such information.

In general, the financial institution FI may be defined as any institution that provides financial services or transactions, such as investments, loans and deposits, to clients or members. Examples of financial institutions include, but are not limited to, banks, trust companies, insurance companies, investment dealers, credit card companies, third-party payment service provides, etc. A merchant M may be defined as any type of merchant, such as a wholesale merchant or retailer, which trades in commodities to earn a profit, online or otherwise. For example, a merchant may be an online retailer selling items, products, merchandise, services or goods to consumers or businesses. A consumer C, in general, is defined as a person or organization that uses economic services or commodities, for example a purchaser or buyer of merchandise from an online merchant.

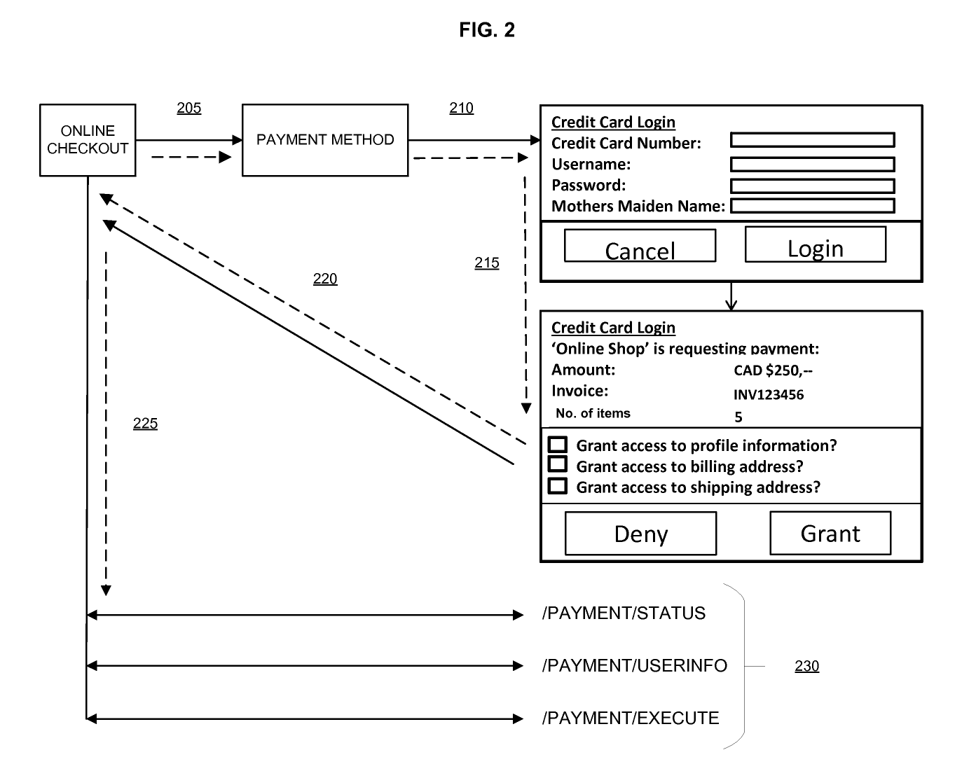

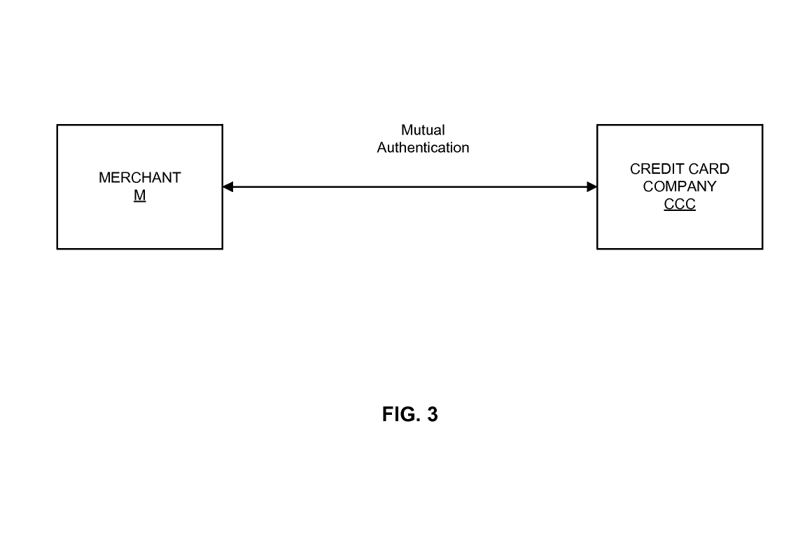

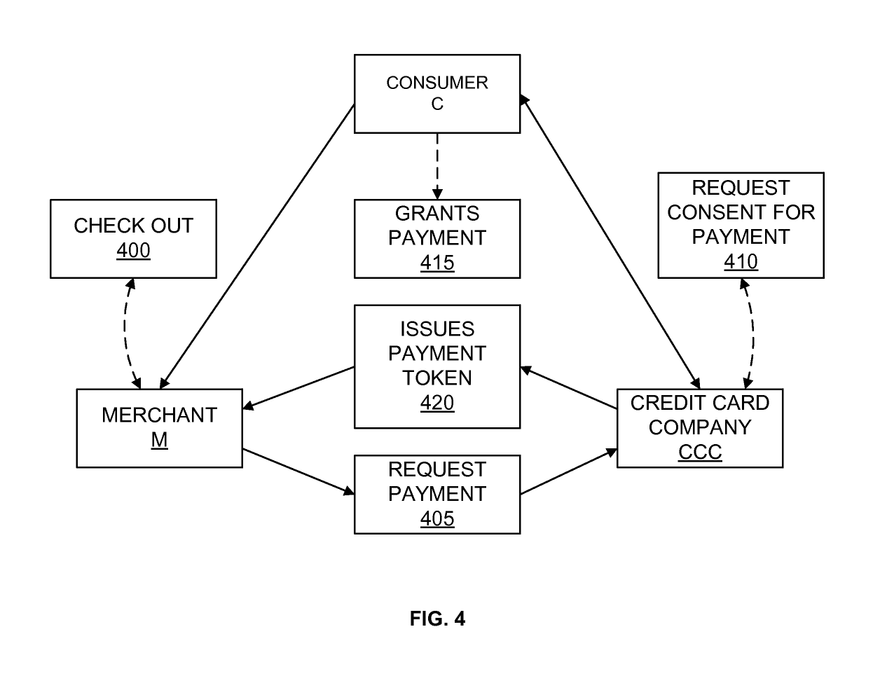

FIG. 2 is an exemplary diagram of a process flow to secure the transfer of financial data during an online transaction. The process depicted in FIG. 2, may be implemented using for example the system of FIG. 1. The process described below is exemplary and is not intended to be limiting. The dashed lines represent the process flow, and the solid lines represent the flow of secure communication during the process. A buyer (such as consumer C on FIG. 1), after shopping on a merchant website, selects to checkout online. The purchase of an item, goods or services online is not described in detail herein, but may constitute any online transaction of a buyer/consumer with an online merchant/business. Upon selecting to checkout online, the buyer is presented with an option to select a form of payment (205). As described above, the buyer is redirected to a website of the financial institution FI (for example, an authorization server of the financial institution) that is associated with the form of payment selected by the buyer (210). The form of payment may be any form of payment that can be processed online, such as a debit card, third party service provider (such as PayPal™), online check, etc. In the exemplary embodiment depicted, the buyer has selected to pay by credit card and is redirected to a login screen or website of the credit card company for which form of payment was selected. The redirection from the online merchant to the login screen of the credit card company occur as follows. The online merchant requests a payment authorization code from the credit card company using a mutually secure connection or mutual authentication (described below with reference to FIG. 3), which includes a scope having the amount and/or unit, order number, etc. The credit card company validates the request for the authorization code and issues the payment authorization code to the merchant M. The merchant M then requests a payment (access) token (for later use in the process) and the buyer is redirected to the credit card login screen upon the original payment request. As described below with reference to FIGS. 3 and 4, the process utilizes an authentication protocol, such as OAuth, and an added identity layer, such as OpenID Connect, to provide resource sharing without divulging unauthorized consumer financial and profile information. The process is also described in more detail below with reference to FIGS. 9-15. It is appreciated that the above example is one embodiment of information being presented to the buyer on a website of the credit card company, and that any different number of varying screens may be displayed, as readily understood by the skilled artisan.

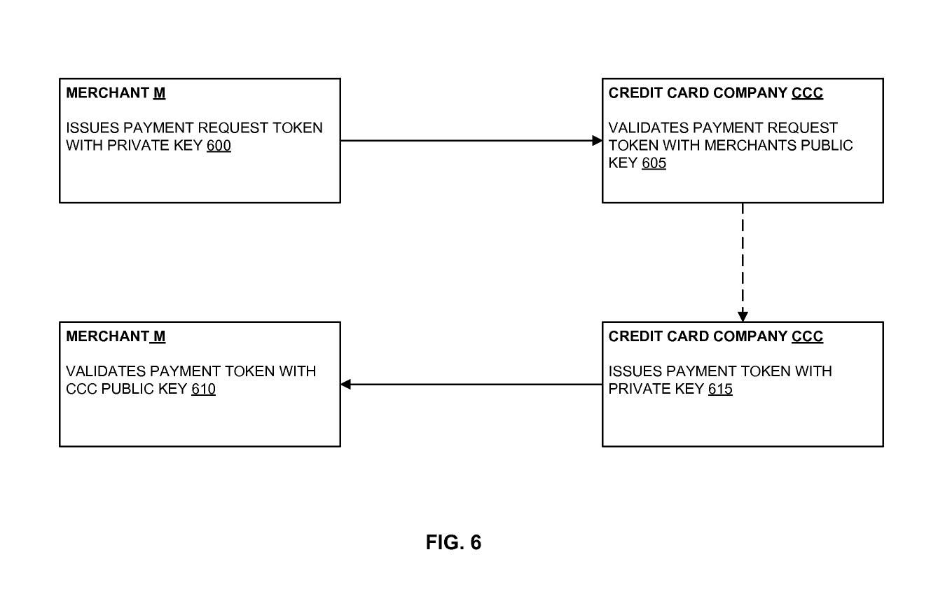

As illustrated in FIG. 2, the credit card login screen first requests the buyer to verify and authenticate the credit card information and account by inputting credentials such as “Credit Card Number”, “Username”, “Password” and “Mothers Maiden Name”. If the information is not verified, then the buyer may be presented with the opportunity to try again, or the buyer may be directed back to the merchant website or the transaction may otherwise be terminated. Once the buyer is verified and authenticated, a payment screen may be presented to the buyer detailing the online merchant request for payment (e.g., transaction details). In this example, the online merchant is requesting payment in the “Amount: CAD $250,--” for “Invoice: INV 123456” to pay for the “No. of items: 5” in the online shopping cart. The buyer may “deny” or “grant” the requested payment (215). If payment is denied, the process ends and the buyer may be redirected to the merchant website or the transaction may be cancelled. If the buyer decides to grant payment, she may also grant access to consumer (buyer) profile information to the online merchant. For example, the consumer profile information may include profile information, billing address and/or shipping address, as depicted in the figure. In the illustrated example, the buyer grants access to the payment request, but does not provide access to the consumer profile information (as no box has been selected to the profile information, billing address or shipping address). Using a JSON web token (JWT) signed by the credit card company, described below with reference to FIG. 6, the credit card company issues a payment token (access token) to the online merchant (220). The payment token includes, for example, expiration token information and the scope of the payment token (including, in the exemplary embodiment, status, user information and execution of the requested payment). Once received by the online merchant, the payment token may be used by the online merchant to request payment and/or consumer profile information. The request is made using a JWT signed by the online merchant to the credit card company. In response to the request, the credit card company provides the merchant with the information previously granted by the buyer. In this example, the credit card company will provide the scope of the payment token as the status being granted, user information (profile information, billing address, shipping address, etc.) being denied and the payment as being “executed” (i.e., approved) (230). The process is described in more detail with reference to FIGS. 9-15 that follow.

FIG. 3 is an exemplary block diagram of a providing security on a network layer of an infrastructure for use with the system and process of FIGS. 1 and 2. In the example that follows, a credit card company CCC is used as an example of the financial institution FI. However, it is appreciated that any financial institution FI may be used, and the disclosure is not limited to the credit card company CCC. Using a mutual authentication as a connection between the merchant M and credit card company CCC (or any financial institution FI associated with the form of payment), the merchant M and credit card company CCC may be authenticated with non-repudiation, which provides a high level of security using digital signatures. As part of the mutual authentication, a digital certificate is required by the parties in order to prove ownership of a public key. In order to provide this level of ownership, a public key infrastructure (PKI) is utilized as well understood by the skilled artisan. As illustrated in FIG. 3, the connection between the merchant M and the credit card company CCC is a mutually authenticated (2-way) connection. The merchant M has a private key and trusts the public key of credit card company CCC. Similarly, the credit card company CCC has a private key and trusts the merchant public key. The private and public keys are used in a manner such that the connection becomes mutually authenticated. A discussion of the mutual authentication will not be described in detail as it is a well-known mechanism by those skilled in the art. However, communications between the merchant M and credit card company CCC will have an added layer of network security as a result of this mechanism. As appreciated, the added level of network security is particularly valuable in financial transactions, in which the information being exchanged is particularly private and any breach or misappropriation of the information could have seriously negative consequences.

FIG. 4 is an exemplary block diagram of an open standard to authorization for use with the system and process of FIGS. 1 and 2. An open standard to authorization, such as the open standard OAuth authorization framework, enables a third-party application to obtain limited access to an HTTP service. More specifically, and as understood by the skilled artisan, OAuth provides client applications a “secure delegated access” to server resources on behalf of a resource owner. It specifies a process for resource owners to authorize third-party access to their server resources without sharing their credentials. OAuth essentially allows access tokens to be issued to third-party clients by an authorization server via an HTTP connection, with the approval of the resource owner, or end-user. The client then uses the access token to access the protected resources hosted by the resource server. A high-level process flow of OAuth is described as follows. A client requests authorization from a resource owner, which authorization can be made directly to the resource owner or indirectly via an authorization server as an intermediary. The client receives an authorization grant, which is a credential representing the resource owner's authorization. The client requests an access token by authenticating with the authorization server and presenting the authorization grant. The authorization server authenticates the client and validates the authorization grant, and if valid, issues an access token. The client requests the protected resource from the resource server and authenticates by presenting the access token, and the resource server validates the access token, and if valid, serves the request.

In the embodiment illustrated in FIG. 4, a consumer C purchases an item from a merchant website and checks out at 400. The merchant M sends a request for payment to the credit card company CCC of the consumer C at 405. The credit card company CCC requests a consent for payment at 410 by the consumer C to authorize the request for payment made at 405 by the merchant M. If the consumer C authorizes the request for payment, then the payment is granted at 415 and an access (payment) token is issued by the credit card company CCC to the merchant M at 420. A further description and embodiments of the implementation of OAuth as it is used in the system and method of this disclosure will be described below with reference to FIGS. 9-15.

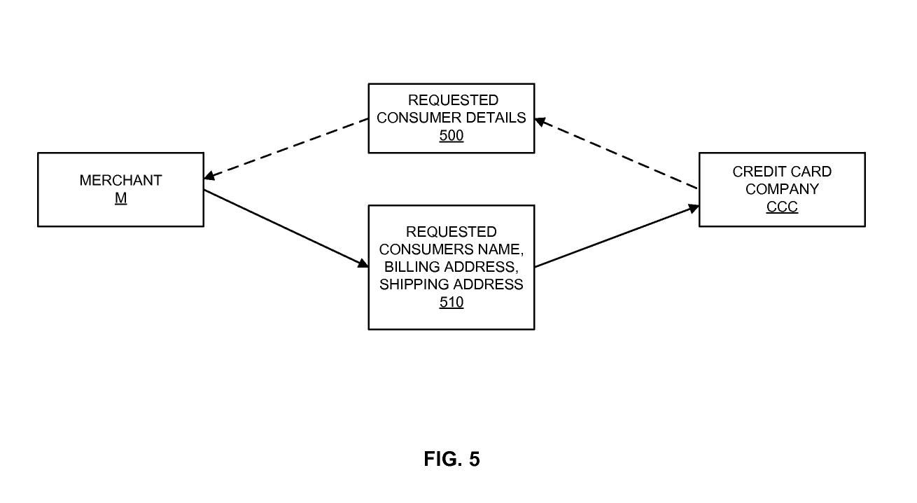

FIG. 5 is an exemplary block diagram of an authorization layer framework for use with the open standard of FIG. 4. An additionally provided layer of security, such as OpenID Connect, is a simple identity layer on top of the OAuth protocol. It allows clients to verify the identity of the end-user based on the authentication performed by an authorization server, as well as to obtain basic profile information about the end-user. OpenID Connect allows clients of all types, including web-based, mobile, and JavaScript™ clients, to request and receive information about authenticated sessions and end-users. In the embodiment illustrated in FIG. 5, the OpenID Connect is leveraged to enable the merchant M to request and receive “claims” (i.e., information about a consumer) that is provided by the financial institution (e.g., credit card company) of the consumer C when properly authorized. For example, during a consumer C transaction with a merchant website (of merchant M), the merchant M may request details about the consumer at 500. For example, the merchant M may request from the credit card company CCC the consumer's C name, shipping address and billing address in addition to the information provided as a result of the request for payment at 510. The consumer details and authorization required to obtain them will be discussed in more detail below. In particular, a further description and embodiments of the implementation of OpenID Connect as it is used in the system and method of this disclosure will be described below with reference to FIGS. 9-15.

FIG. 6 is an exemplary block diagram of an open standard format used to transmit data objects as a web token for use with the system and process of FIGS. 1 and 2. Another open standard to authorization is, for example, JSON (JavaScipt Object Notation), which is primarily used to transmit data between a server and web application as an alternative to XML. JSON utilizes objects and arrays for data interchange, where an object is defined as an unordered set of name/value pairs and an array is defined as an ordered collection of values. A JSON Web Token (JWT) is a compact URL-safe mechanism of representing claims (information) to be transferred between two parties. The claims in a JWT are encoded as a JSON object (described above) that are digitally signed using a JSON Web Signature. In the embodiment illustrated in FIG. 6, JWT is used for all exchanged messages between the merchant M and the credit card company CCC. This allows both parties to create and receive digitally signed messages, which introduces non-repudiation. Thus, non-repudiation exists from end-to-end instead of point-to-point independent of the network protocol. For example, a merchant M issues a payment request token with a private key at 600 to the credit card company CCC. The credit card company CCC, at 605, validates the payment request token with merchant's M public key, and issues a payment token with a private key at 615. At 610, the merchant M validates the payment token with the credit card company's CCC public key. A further description and embodiments of the implementation of MT as it is used in the system and method of this disclosure will be described below with reference to FIGS. 9-15.

FIG. 7 is an exemplary flowchart illustrating an embodiment of a merchant registering with a financial institution in accordance with the system and process of FIGS. 1 and 2. To establish secure and trustworthy communication between the merchant M and a financial institution FI, the merchant M registers with each financial institution FI that it will conduct business with at 705. For example, the establishment of a relationship may include the merchant M opening a new account with the financial institution FI similar to how a personal investor (consumer) would open a new account with its own financial institution. The distinction here being that the merchant M is creating the new account with the same financial institution FI as the consumer. Establishing a relationship with the financial institution FI by the merchant M, in addition to establishing a new account, is a fundamental process that ensures a level of security and trustworthiness that will be required prior to conducting any business, especially any business related to private and otherwise secure data. In this exemplary embodiment, the merchant M is an online merchant, such as a merchant website, and the financial institution FI is a credit card company CCC of the consumer C that will be purchasing and paying for an item on the merchant website as an online transaction. It is appreciated that the merchant website is merely exemplary in nature, and that any online site that allows consumers to pay for items, products, goods, services, etc. may register with the financial institution FI. Likewise, it is appreciated that the credit card company CCC may be any form of payment used in an online transaction, such as a debit card, third party service provider (such as PayPal™), online check, etc., which form of payment may be supported as an option on the merchant website. After the secure exchange of information and completion of the registration process, the parties have established a secure relationship at 715, which provides the two parties with the ability to communicate using secure transactions at 720. For example, messages exchanged between the merchant M and financial institution FI will be digitally signed by JWT (described above), using either the merchant's M or financial institution's FI private key. Tokens, such as authorization code, access token, etc., are placed within a JWT and are therefore signed. Moreover, mutually secure connection (i.e., mutual SSL) is used for communications between the merchant M and the financial institution FI as soon as registration is completed, thereby securing transactions at 720. Additionally, transactions may be further secured using (1) nonce values, (2) tokens with limited lifetimes, and/or (3) token expiration after a single use for payment execution.

As an example of a merchant M registering with a financial institution FI, the merchant M may login to a registration website of the financial institution to create a new account. The login or registration screen may first ask the merchant M to provide a username and password for use with the new account. Once the username (and password) are approved by the financial institution FI, an account number may be issued to the merchant M. The newly opened account with the financial institution FI may then be accessed by the merchant M to set up bank information, such as the merchant's M bank account to enable monies to be transferred from the financial institution FI. As explained above, via this registration process, a trustworthy and secure connection is formed between the merchant M and the financial institution FI, without requiring an intermediary or third party to process any communication or financial transaction.

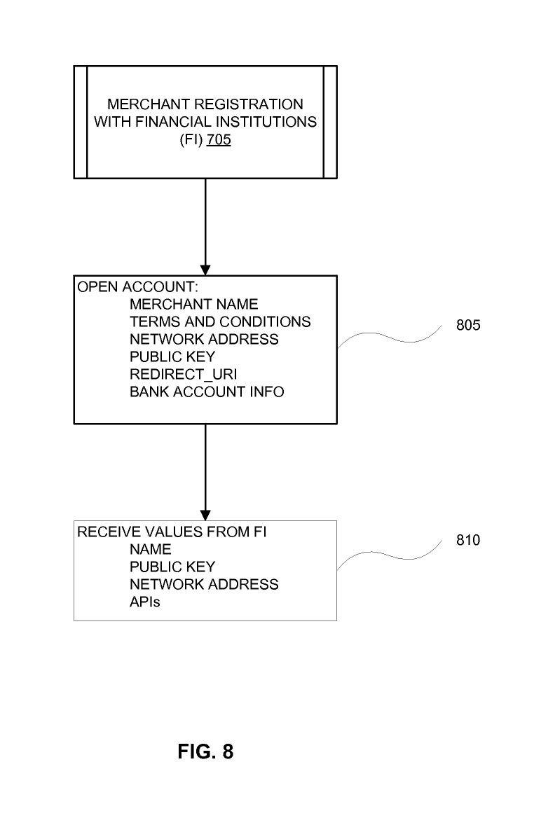

FIG. 8 is another exemplary flowchart illustrating an embodiment of a merchant registering with a financial institution in accordance with the system and process of FIGS. 1 and 2. As an initial part of the registration process at 705 (see also FIG. 7), the merchant M provides various values to the financial institution FI as part of opening an account. These values are used to establish an account such that the two parties can form a trusted relationship for secure communication. The values may include for example, but are not limited to, the merchant name, the merchant terms and conditions, the merchant owner, the merchant network address, the merchant public key, the merchant redirect_uri which will be used by the financial institution FI after a consumer C (buyer) has selected a payment method (form), and the merchant bank (financial institution) account information which will be used by the financial institution FI to transfer the requested payment amount (805). Upon receipt of the values from the merchant M, the financial institution FI issues values back to the merchant M to complete the opening of the account. The values issued by the financial institution FI include for example, but are not limited to, the financial institution name, the financial institution public key, the financial institution network address and the financial institution APIs that are required to exchange protocol related requests (810). It is appreciated that the values issued by the merchant M and the financial institution FI are exemplary in nature and that alternative and/or additional values may be utilized in a manner well understood by the skilled artisan.

FIG. 9 is an exemplary flowchart illustrating the process of securing the transfer of payment for an online transaction in accordance with the system of FIG. 1. The process below details events that follow the merchant registration and the purchase of an item(s) at a website or online store of the merchant M, as described above with reference to FIGS. 7 and 8. Financial data and account information of a consumer C is stored at a financial institution FI having a relationship with the consumer C at 905. For example, the consumer C may have a bank account and/or credit card account with the financial institution FI, which bank account and/or credit card account information (i.e., financial data and account information) may be stored with the financial institution FI. The financial data and account information may be stored, for example, in a database, a data storage device, a designated server system or computing system, or a designated portion of one or more server systems or computing systems, or a distributed database, or by any other well-known means. At 910, a financial institution server FI of the financial institution FI receives a payment request from a merchant M. The payment request made by the merchant M is in response to an online transaction made by the consumer C at the website of the merchant M. The transaction prompts payment, including selection of a form of payment by the consumer C, which then redirects the consumer C from the merchant website to a website of the financial institution FI associated with the form of payment. In particular, the redirection from the merchant website to the financial institution FI website results from a direct request from the merchant M to the financial institution FI, which request includes an authorization (temporary) code and scope of the payment request using mutual authentication. The scope of the payment request includes, for example, the status of the payment (after the payment token has been issued) and consumer profile information. Upon validating the merchant M, the authorization code is issued back to the merchant M and a payment (access) token is requested by the merchant M. At this time, the request C is redirected to the financial institution FI. Notably, there is no intermediary or third party (e.g., payment service provider (PSP), acquirer, etc.) involvement between the merchant M and the financial institution FI during the communication there-between. It is appreciated, however, that the merchant M could also be any server, processor, computer, component or entity that is part of or directly associated with the merchant M, such as a merchant server network, merchant server system or merchant bank. The consumer C is then presented with a login screen at the website of the financial institution FI in order to authorize the payment request made by the merchant M and to verify the consumer's C account information (915). The authentication and verification is validated when the consumer C enters credentials (e.g., credit card or account number, username, password, security question response, etc.) into the login screen of the financial institution website. If authentication is successful, then the financial institution FI proceeds to determine whether the merchant M is authorized for payment, at 920. If, on the other hand, authentication is not successful, the consumer C may be given the opportunity to reenter the information, be redirected back to the merchant website or the transaction terminated (request denied at 930). At 920, the financial institution FI authorizes the merchant M by issuing a payment token to the merchant M (this is in response to the merchant's M earlier request for a payment token at 910). Issuing the payment token to the merchant M establishes a trusted relationship between the financial institution FI and the merchant M, and grants the merchant M access to an account at the financial institution FI. If the payment token is not properly received or acknowledged by the merchant M, then authorization is denied and the transaction is terminated (deny request 930).

When issuing the payment token to the merchant server M, the financial institution server FI may also include an identification token. The identification token includes the consumer profile information, such as billing address, shipping address and contact information. However, the identification token is only sent to the merchant M when access to the information has been permitted by the consumer C (925). For example, during the authentication of the consumer account at the website of the financial institution FI, the login screen (FIG. 2) may also provide the consumer C with an opportunity to grant or deny access to consumer profile information. As noted, the consumer profile information may include various information, such as the profile information, billing address and shipping address information displayed on the login screen of FIG. 2. If any or all of the information is granted by the consumer C during login, then the financial institution FI transmits the identification token (including the granted information) to the merchant M along with the payment token. As an added layer of security, the payment token has an expiration status that may be set, for example, to expire after the completion of one payment or payment execution (approval) or after a time interval. Thus, the merchant M will be required to request another payment token for additional payment by the financial institution FI. If access to the consumer profile information is not permitted by the consumer C, then the payment is executed by the financial institution FI to the merchant M at 940 without any consumer profile information. If, on the other hand, the consumer C permits access to the consumer profile information, then the consumer profile information (or any portion thereof) is sent with the payment from the financial institution FI to the merchant M using the identification token (935) and the payment is executed by the financial institution FI to the merchant M at 940. Transmission of the payment by the financial institution FI to the merchant M uses a mutually secure connection after establishment of the trusted relationship (as described above). During the entirety of the process, unless specifically granted by the consumer C, no financial data or details is exchanged with the merchant M, either from the consumer C or the financial institution FI. This provides a robust and secure payment network in which fewer parties have or are granted access to the financial data of the consumer C.

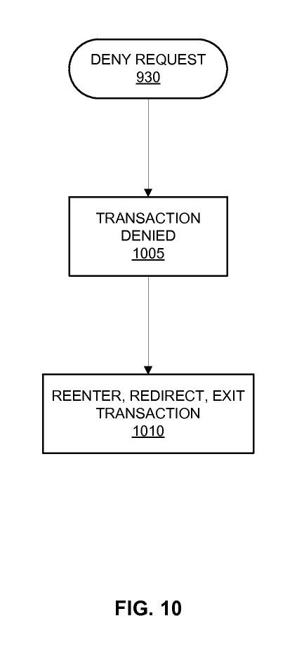

FIG. 10 is an exemplary flowchart illustrating the denial of a request for payment of an online transaction in accordance with FIG. 9. As illustrated in FIG. 9, a merchant M request for payment may be denied if the consumer C fails to be authenticated by the financial institution FI during the login process (915) or if the request for payment is not authorized (920), for example as a result of a failure to establish a trusted and secure connection. In the event of a failed authentication or authorization, the transaction at the merchant website by the consumer C is denied at 1005. Denial of a transaction may result in the financial institution FI requesting the consumer C re-enter credentials at the login screen, redirecting the consumer C back to the merchant website, or terminating the transaction (1010). Similarly, if the financial institution FI is unable to authorize the merchant M (as described above with reference to FIG. 9) then the transaction is denied (1005) and the financial institution FI redirects the consumer C back to the merchant website, or exits the transaction without completing the transaction (1010) until authorization is verified.

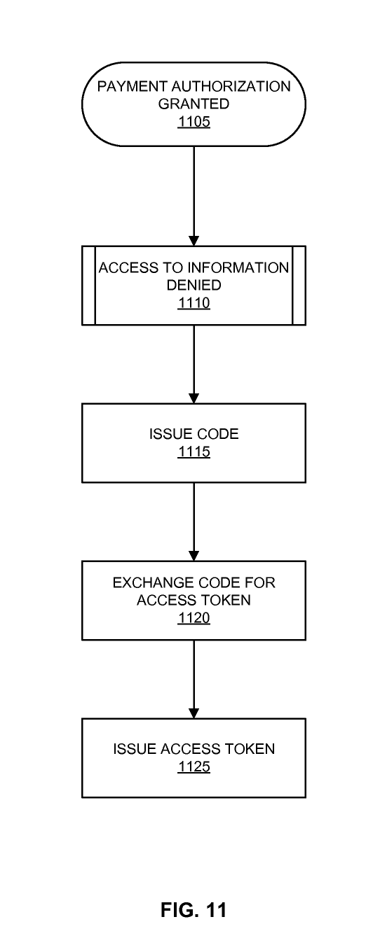

FIG. 11 is an exemplary flowchart of payment authorization for a payment made during an online transaction in accordance with FIG. 9. When a request for payment from a merchant M has been authorized (1105), the financial institution FI then determines whether the customer C has granted or denied access to consumer profile information (at 925 of FIG. 9). When access is denied by the customer C at 1110, the financial institution FI issues an authorization (temporary) code to the merchant M at 1115, which exchanges the authorization code for a payment (access) token at 1120. The payment token is issued by the financial institution FI to the merchant M (1125), which permits the merchant M to obtain status information about the requested payment transaction. As explained above, the payment token includes information such as the status of the token, expiration of the token and execution of the token (together comprising the scope of the payment token). Upon receipt of the payment token by the merchant M, the merchant M requests the status of the payment using the payment token. Since the status of the payment token (in this example) is marked as granted, payment will be executed by the financial institution FI to the merchant server M using the payment token without transmitting any of the consumer profile information (since access to the consumer profile information was denied by the consumer).

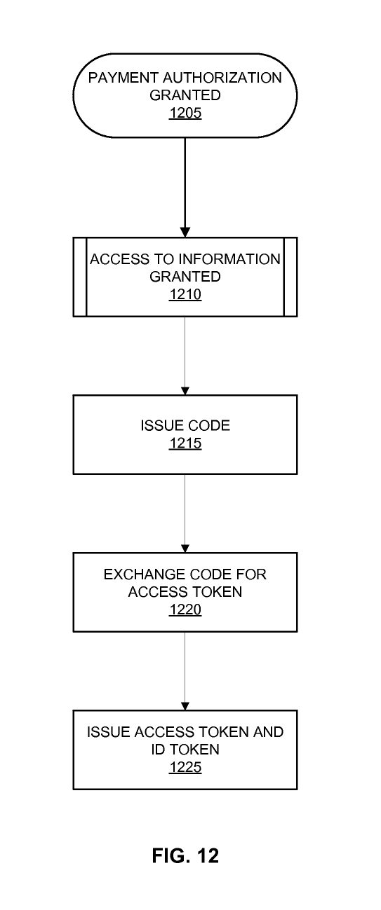

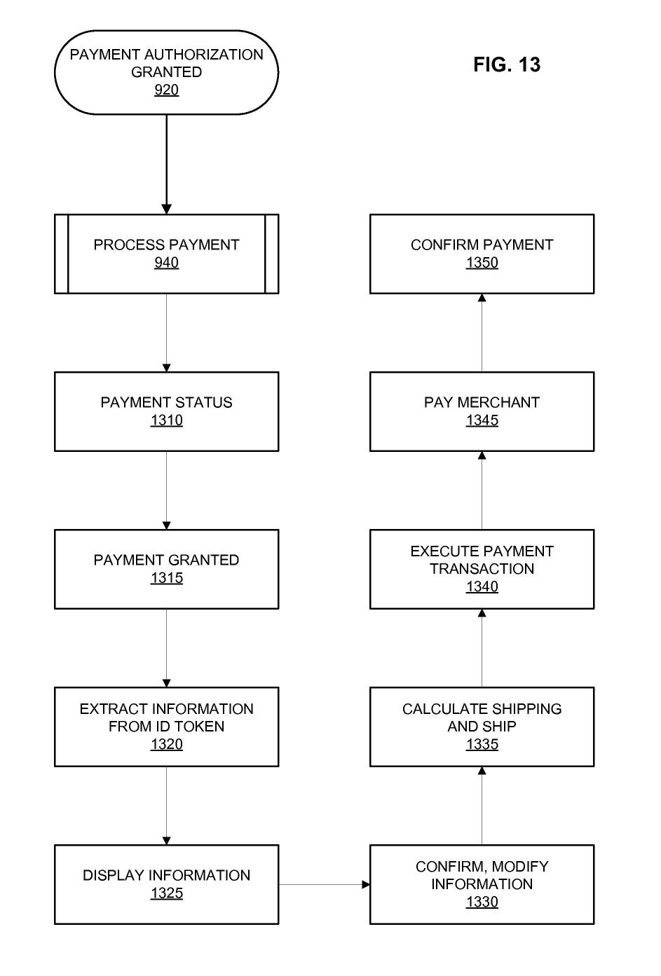

FIG. 12 is another exemplary flowchart of payment authorization for a payment made during an online transaction in accordance with FIG. 9. FIG. 12 is similar to FIG. 11 with the exception that the merchant server M is granted access to the consumer profile information during the authorization phase. When a request for payment from a merchant M has been authorized (1205), the financial institution FI then determines whether the customer C has granted or denied access to consumer profile information (at 925 of FIG. 9). When access is granted by the customer C at 1210, the financial institution FI issues an authorization (temporary) code to the merchant M at 1215, which exchanges the authorization code for a payment (access) token at 1220. The payment token is issued by the financial institution FI to the merchant M (1225), which permits the merchant M to obtain status information about the requested payment transaction. Additionally, since the merchant M has been granted access to the consumer profile information, an identification token (ID token) is also issued to the merchant M by the financial institution FI (1225). As explained above, the payment token includes information such as the status of the token, expiration of the token and execution of the token (together comprising the scope of the payment token). The identification token, on the other hand, includes the consumer's C consumer profile information, such as billing address and shipping address. Upon receipt of the payment token and identification token by the merchant M, the merchant M requests the status of the payment using the payment token. Since the status of the payment token is marked as granted (in this example), payment will be executed by the financial institution server FI to the merchant M using the payment token. Additionally, the identification token will be issued to the merchant M, which token will provide the merchant server M with the granted consumer profile information. A description of the payment processing will be described below with reference to FIG. 13.

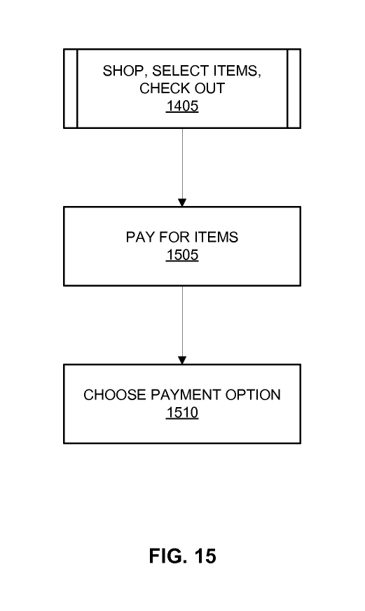

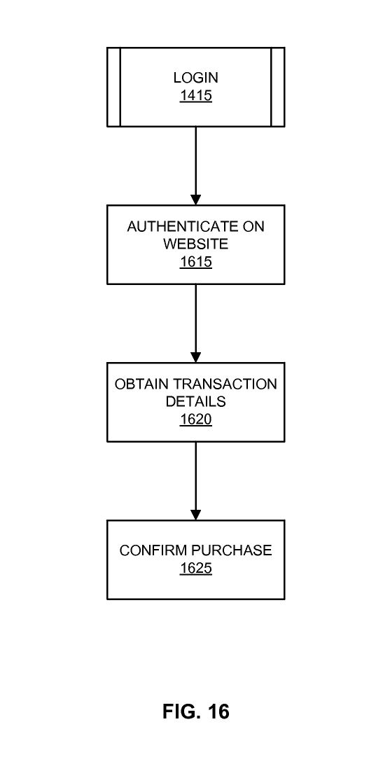

FIG. 13 is an exemplary flowchart of processing payment made during an online transaction in accordance with FIG. 9. After payment has been authorized (granted) by a consumer C at (920, FIG. 9), payment may be processed by the financial institution FI to the merchant M (940, FIG. 9). Initially, a payment (access) token is issued from the financial institution FI to the merchant M. The payment token includes, among other data, a scope of the token to indicate status, expiration, etc. Upon receipt of the payment token at the merchant M, the merchant M sends a request about the status (scope) of the requested payment to the financial institution FI at 1310. The status inquiry is sent using the payment token sent by the financial institution FI after having been validated by the merchant M. The financial institution FI verifies that status of the payment token as having been granted, and executes a payment grant to the merchant M at 1315. The payment grant indicates to the merchant M that payment has been authorized and the transaction may continue. Notably, the expiration of the payment token adds a level of security to the communication. At 1320, if the consumer C has authorized the grant of consumer profile information to the merchant M, the financial institution FI sends an identification token to the merchant M. The identification token includes the consumer profile information having been granted by the consumer C, which information is extracted from the token at the merchant M for display on the merchant website (1325). For example, the merchant website may present the consumer's C billing and shipping address prior to sending the item(s) purchased on the merchant website by the consumer C. The displayed consumer profile information may be confirmed or modified by the consumer C as necessary at 1330 (e.g., modified to correct shipping address), and the merchant M calculates shipping costs (shipping costs may be estimated or set as a maximum in the original request, or a separate request may be generated to include the actual shipping charges) and ships the item(s) having been purchased by the consumer C on the merchant website (1335) (payment selection and authentication is discussed with reference to FIGS. 15 and 16 below). After shipping the items, the merchant M executes a payment transaction (using the payment token) to the financial institution FI (1340), and the financial institution FI pays the merchant (1345) and confirms payment (1350). In the example, since the payment token expires after a single payment (indicated as part of the scope of the token), the payment token may no longer be used for further communication.

As explained above, the payment process utilizes various secure connections and protocols in order to communication and transmit the private financial data and consumer profile information. For example, PKI adds a network layer security by authenticating the network layer for https and mutual SSL communications. The merchant M has a private key and trusts the financial institutions FI (in this example, credit card company) public key. The credit card company CCC also has private key and trusts the merchant's M public key. For issuance of the payment token (and requesting payment), OAuth is utilized such that financial information may be communicated without sharing or restricting access to (based for example on rules governing access) any of the consumer C financial details with the merchant M. Additionally, as an added identity layer to OAuth, OpenID Connect is utilized to communicate consumer profile information when authorized by the consumer C. Finally, JWT leverages PKI and implements digital signatures for communication, as well as providing tokens as part of the secure communication. When a merchant M communicates with the financial institution FI, the communication (e.g., payment request) is signed using a token with a private key such that the financial institution FI (e.g., credit card company) can validate the payment requested token with the merchant's public key. Similarly, when the financial institution FI communicates with the merchant M, an issued payment token is signed with a private key such that the merchant M can validate the payment token with the financial institution's FI public key. It is also appreciated that various forms of securing communication between the parties may be used, and the disclosed embodiments are exemplary in nature and non-limiting.

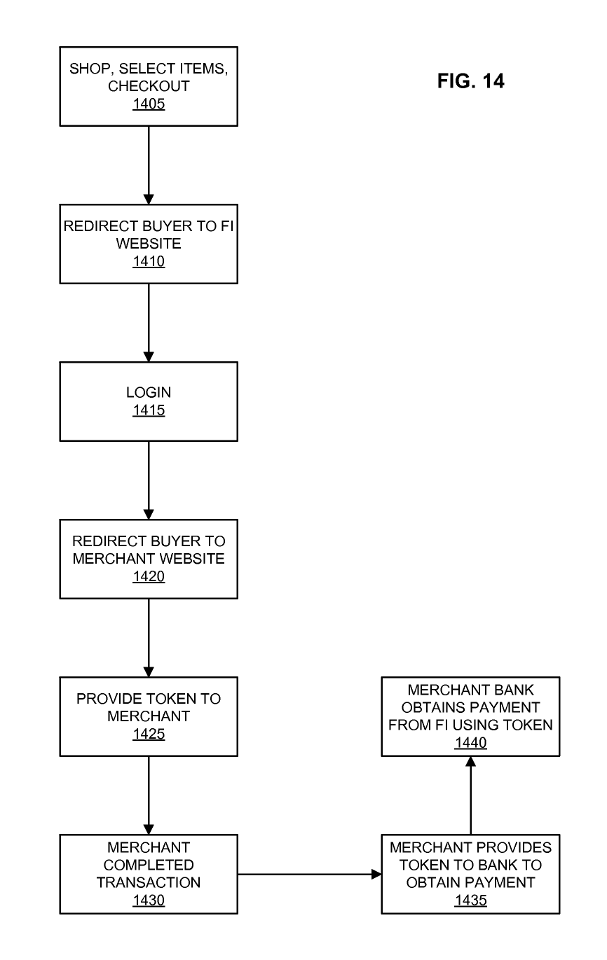

FIG. 14 is an exemplary flowchart illustrating another process of securing the transfer of payment for an online transaction in accordance with the system of FIG. 1. At 1405, a consumer C shops at an online retailer or merchant M for the purchase of items, goods, services, etc. (collectively, items). Once the consumer C has placed items in a shopping cart for purchase, the consumer C begins the checkout process. The shopping and purchasing of such items in this case is considered an online transaction. Further details of the shopping and checkout at 1405 may be found with reference to FIG. 15 below. At checkout, the consumer C is presented with payment options on the login screen of a website associated with the merchant server M. The consumer C selects a payment option, and is redirected to a website of the financial institution FI associated with the selected payment option (1410). For example, if the consumer C selects to pay for the online transaction using a credit card, then the consumer C is redirected from the merchant website to the website of the credit card company CCC. The redirection, in one embodiment, occurs transparently to the consumer C, such that the user interface on the website appears to transition without knowledge of the consumer C. In another embodiment, the consumer C may knowingly be redirected to the credit card company CCC website. For example, the merchant website may state “please hold while you are redirected to the credit card company” or the like. At the credit card company login website (1415), the consumer C enters credentials to verify and authorize the account for payment. An example login screen is illustrated in FIG. 2, and a discussion of the login process follows with reference to FIG. 16.

At 1420, and after logging into and authorizing payment, the consumer C is redirected back to the merchant website to continue the checkout process (1420). Back at the website of the merchant M, the consumer C may continue to shop or edit information, such as consumer profile information, provided as part of completing the checkout. In conjunction with the redirect, the financial institution FI issues a temporary token (authorization code) to the merchant M at 1425. The payment token either grants or denies a request for payment as a result of the consumer's C purchase online at the merchant website. If the payment token grants payment, the merchant M completes the transaction at 1430 by validating the payment token and issuing the validated payment token to the financial institution FI. Upon receipt of the payment token from the merchant M, the financial institution FI executes payment (1440).

FIG. 15 is an exemplary flowchart of shopping and payment selection in accordance with FIG. 14. FIG. 15 shows another embodiment of FIG. 14 in which a user and search interface are presented on a web browser for online shopping. For example, online shopping at a merchant website may include a user interface accessed through a web browser, a computer application, a mobile device application, or in any other well-known manner. A typical user interface for shopping online includes a search interface specifically designed to search for goods or services being offered by the merchant M. For example, a consumer C using the search interface may search for a clothing item, a retailer, a brand, or any other category. The user interface displays one or more items of apparel and associated information, such as a description, brand, color, size, style, trend, price, and the like after a consumer C performs a search for items. After completing the search for items, the consumer C selects the items for purchase and places them in an online shopping cart (1405). When the consumer C has finished shopping, she opens the shopping cart and selects the option to pay for the items (1505). For example, the user interface may display the shopping cart which identifies 5 items that have been selected for purchase by the consumer C, including the price for each item and a total price of items in the shopping cart. Displayed with the shopping cart is a payment button that allows the consumer C to select the form of payment to purchase the items (1510). For example, the user interface may display three payment options: 1) credit card, 2) debit card, or 3) electronic check. The consumer C may select any of the options such that the transaction continues in the manner consistent with the above description. It is appreciated that the user interface and payment options described above are exemplary and not intended to be limiting.

FIG. 16 is an exemplary flowchart of a login process for payment during an online transaction in accordance with FIGS. 2 and 14. The consumer may be presented with a login screen or site that includes fields for the consumer C to enter an account number, username or email address, password and security question (1415). Once the consumer C enters authenticating credentials at login (1615), transaction details may be obtained and displayed to consumer C (1620). For example, the consumer C is provided with information regarding the selected card information, such as account information, the name of the merchant M requesting payment, the amount of the requested payment, an invoice number and a list of items for purchase (i.e., a list of items in the consumer's C shopping cart). At 1625, the consumer C confirms the purchase by granting payment, thereby authorizing the financial institution FI to grant a payment token to the merchant M, as discussed above.

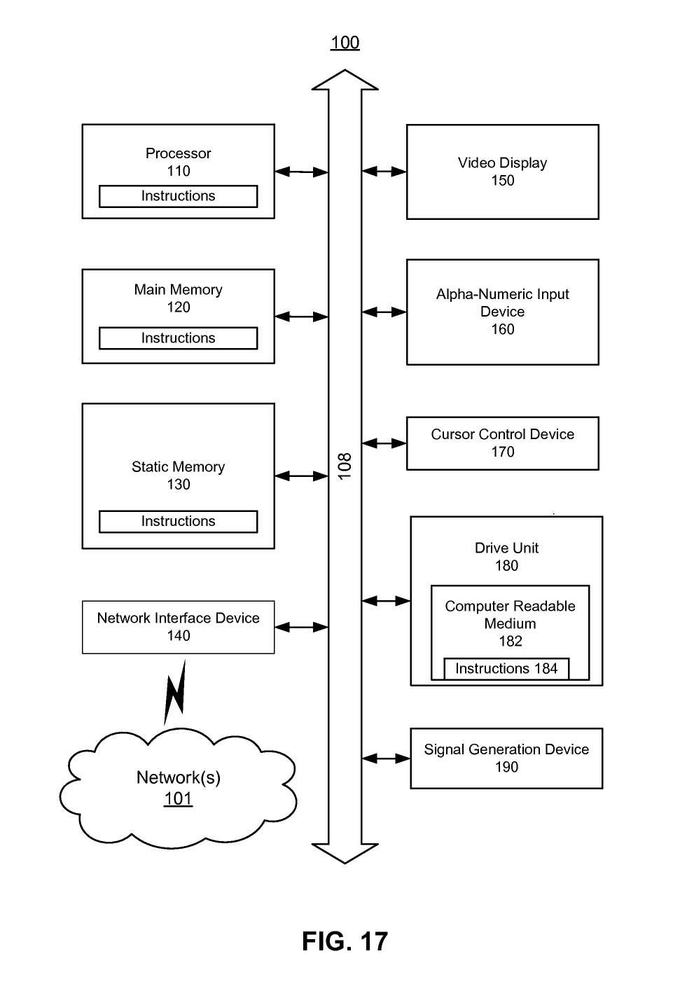

FIG. 17 is an illustrative embodiment of a general computer system. The general computer system which is shown and is designated 100 may be used to implement the device illustrated in FIGS. 1, 2, 9 and 14. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices. As illustrated in FIG. 17, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 100 includes a main memory 120 and a static memory 130 that can communicate with each, and processor 110, other via a bus 108. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory describe herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted.

As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen or pad. The computer system 100 can also include a disk drive unit 180, a signal generation device 190, such as a speaker or remote control, and a network interface device 140.

In a particular embodiment, as depicted in FIG. 17, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In a particular embodiment, the instructions 184 may reside completely, or at least partially, within the main memory 120, the static memory 130, and/or within the processor 110 during execution by the computer system 100.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In a networked deployment, the computer system 100 may operate in the capacity of a server or as a client user computer in a server-client user network environment, or as a peer computer system in a peer-to-peer (or distributed) network environment. The computer system 100 can also be implemented as or incorporated into various devices, such as an call interceptor, an IVR, a context manager, an enrichment sub-system, a message generator, a message distributor, a rule engine, an IVR server, an interface server, a record generator, a data interface, a filter/enhancer, a script engine, a PBX, stationary computer, a mobile computer, a personal computer (PC), a laptop computer, a tablet computer, a wireless smart phone, a personal digital assistant (PDA), a global positioning satellite (GPS) device, a communication device, a control system, a web appliance, a network router, switch or bridge, a web server, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As a result of the system and method described above, and in particular, with reference to the system and methods of FIGS. 1, 2 and 9-17, a secure online transaction and payment may be performed. The system and method provides consumers with an added level of security by having merchants communicate directly with a financial institution of the consumer, without sharing or restricting access to any of the financial details about the consumer. For example, there is no sharing of credit card details with the merchant, credit card details cannot be hijacked or stolen from merchants since they do not have access to or store the financial information, and credit card details cannot be fraudulently misused by employees or other members. The system also ensures that the financial institution, and not the merchant, is responsible for storing consumer profile information, which information is only supplied to the merchant upon consent by the consumer. Moreover, the communication between any of the consumer, merchant and financial institutions utilizes secure technologies and mechanisms such as PKI, OAuth, OpenID Connect and JSON web token (JWT). Thus, merchants, consumers and financial institutions may form trusted relationships in which communications between the parties is secure and private data is not shared with the merchant or third parties, thereby minimizing the risk of such private data being used illegally or fraudulently. It is also appreciated that the technologies and secure mechanisms used in the disclosed embodiments are non-limiting, and that any form of secure communication currently available or contemplated in the future may be used.

In one embodiment, there is an apparatus to secure financial data in a network, including a storage system to store financial data, credentials, access restriction data and profile information of a first client coupled to the network, the first client registered with a financial institution; and a payment server in communication with the storage system and associated with the financial institution of the first client, the payment server further comprising a receiver to receive a payment request directly from a merchant server, the payment request comprising a request for the transfer of payment in response to an online transaction by the first client, the online transaction identifying a form of payment associated with the financial institution and restricting access of payment details to the merchant server based on rules governing the access restriction data; an authenticator to authenticate the first client when identifying the form of payment as part of the online transaction, the first client having been redirected from a website of the merchant server directly to a website of the payment server, and the first client being authenticated when the credentials input by the first client at the website of the payment server are read from the storage system and validated by the payment server; an authorizer to authorize payment to the merchant server in response to the payment request when the credentials are read from the storage system and have been validated by the payment server, the authorization establishing a trusted relationship between the payment server and the merchant server using a first token to grant the merchant server secure access to the payment server and indicate a scope of the payment, and sending the profile information of the first client to the merchant server when approved by the client, the profile information secured by a second token comprising the profile information; and a transmitter to transmit the payment and the approved profile information by the payment server to a financial institution of the merchant server using a mutually secure connection after establishing the trusted relationship.

In another embodiment, there is a method of securing financial data in a network, including storing the financial data, credentials and access restriction data in a storage system of a payment server, the financial data, the credentials and the access restriction data associated with a first client having a financial relationship with the payment server; receiving a payment request by a merchant server at the payment server in response to an online transaction made at a website of the merchant server, the online transaction prompting payment by the first client; authenticating the first client in response to the payment request, after selection of a form of payment identifying the payment server and restricting access of the financial data to the merchant server based on rules governing the access restriction data, the first client having been redirected from a website of the merchant server directly to a website of the payment server, the authentication performed by validating the credentials read from the storage system of the first client accepted at a login screen of the website of the payment server; authorizing the merchant server for payment, in an amount associated with the online transaction, in response to the authentication when the credentials are read from the storage system and validated by the payment server, and obtaining details of the online transaction from the merchant client after confirming authorization, the authorization establishing a trusted relationship between the payment server and the merchant client using a first token to grant the merchant client access to the payment server and indicating a scope of the payment; and transmitting the payment by the payment server to the merchant client using a mutually secure connection after establishing the trusted relationship, and providing profile information of the first client to the merchant client with the transmitted payment using a second token when authorized by the first client.

In still another embodiment, there is a computer program product including a computer readable storage medium having computer readable program code embodied therewith, the computer readable program code comprising: computer readable program code configured to authenticate a client at a website of a payment processor, the payment processor associated with a financial institution of the client and storing client credentials and access restriction data, and receive login credentials from the client to verify a payment associated with an online transaction made on a merchant website, the client being transparently redirected to the website of the payment processor; computer readable program code configured to authorize the payment to a financial institution associated with the merchant website using a first token to grant access to the financial institution of the merchant website and provide a scope of the payment, after the client credentials read from and validated by the payment processor; computer readable program code configured to establish a trusted relationship between the financial institution of the payment processor and the financial institution of the merchant website using the first token; computer readable program code configured to provide a mutually secure connection between the financial institution of the payment processor and the financial institution of the merchant website after establishing the trusted relationship; and computer readable program code configured to remit the payment to a financial institution of the merchant website upon completion of the online transaction by the client, and restricting access of payment details to the merchant website or the financial institution of the merchant website based on rules governing the access restriction data.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus to secure financial data in a network, comprising:
a storage system to store financial data, credentials, access restriction data and profile information of a first client coupled to the network, the first client registered with a financial institution; and
a payment server in communication with the storage system and associated with the financial institution of the first client, the payment server further comprising
a receiver to receive a payment request directly from a merchant server, the payment request comprising a request for the transfer of payment in response to an online transaction by the first client, the online transaction identifying a form of payment associated with the financial institution and restricting access of payment details to the merchant server based on rules governing the access restriction data;
an authenticator to authenticate the first client when identifying the form of payment as part of the online transaction, the first client having been redirected from a website of the merchant server directly to a website of the payment server, and the first client being authenticated when the credentials input by the first client at the website of the payment server are read from the storage system and validated by the payment server;
an authorizer to authorize
payment to the merchant server in response to the payment request when the credentials are read from the storage system and have been validated by the payment server, the authorization establishing a trusted relationship between the payment server and the merchant server using a first token to grant the merchant server secure access to the payment server and indicate a scope of the payment, and
sending the profile information of the first client to the merchant server when approved by the client, the profile information secured by a second token comprising the profile information; and
a transmitter to transmit the payment and the approved profile information by the payment server to a financial institution of the merchant server using a mutually secure connection after establishing the trusted relationship.

2. The apparatus according to claim 1, wherein
the receiver receives a registration request at the payment server to register the merchant server with the payment server, and
the transmitter provides values to the merchant server in response to the registration.

3. The apparatus according to claim 2, wherein the trusted relationship comprises a network level security that is established by:
the transmitter and the receiver exchanging messages between the payment server and the merchant server using a private key;
the transmitter placing tokens within a JSON web token container; and
the transmitter applying mutual SSL for communications after the merchant server is registered with the payment server.

4. The apparatus according to claim 1, wherein the payment server denies the transfer of the payment to the merchant server by the payment server when the first client fails to authorize the payment and exits the online transaction without payment.

5. The apparatus according to claim 1, wherein
when the credentials are validated by the payment server,
the payment server issuing a temporary code to the merchant server by the payment server;
the payment server receiving the first token at the payment server in exchange for the issued temporary code from the merchant server;
when the first client authorizes sending of the profile information, the payment server issuing the first token and the second token to the merchant server by the payment server, the second token comprising the profile information; and
when the first client fails to authorize the sending of the profile information, the payment server issuing the first token to the merchant server, by the payment server, without providing the profile information.

6. The apparatus according to claim 5, wherein when the transmitter transmits the payment,
the receiver receiving a status of the payment using the first token, the status identifying whether the scope of the payment token has expired;
the authorizer granting the payment to the merchant server when the scope of the first token has not expired;
the receiver receiving a payment execution transaction from the merchant server when the payment has been granted, after the profile information has been verified; and
the transmitter paying the merchant server the payment in the amount associated with the online transaction, and confirming payment.

7. The apparatus according to claim 6, wherein the scope of the payment token is defined as expiring after one execution of payment.

8. A method of securing financial data in a network, comprising:
storing the financial data, credentials and access restriction data in a storage system of a payment server, the financial data, the credentials and the access restriction data associated with a first client having a financial relationship with the payment server;
receiving a payment request by a merchant server at the payment server in response to an online transaction made at a website of the merchant server, the online transaction prompting payment by the first client;
authenticating the first client in response to the payment request, after selection of a form of payment identifying the payment server and restricting access of the financial data to the merchant server based on rules governing the access restriction data, the first client having been redirected from a website of the merchant server directly to a website of the payment server, the authentication performed by validating the credentials read from the storage system of the first client accepted at a login screen of the website of the payment server;
authorizing the merchant server for payment, in an amount associated with the online transaction, in response to the authentication when the credentials are read from the storage system and validated by the payment server, and obtaining details of the online transaction from the merchant client after confirming authorization, the authorization establishing a trusted relationship between the payment server and the merchant client using a first token to grant the merchant client access to the payment server and indicating a scope of the payment; and
transmitting the payment by the payment server to the merchant client using a mutually secure connection after establishing the trusted relationship, and providing profile information of the first client to the merchant client with the transmitted payment using a second token when authorized by the first client.

9. The method according to claim 8, further comprising
receiving a registration request at the payment server to register the merchant client with the payment server; and
providing values to the merchant client in response to the registration.

10. The method according to claim 9, the registration request comprising the merchant client name, the merchant client terms and conditions, the merchant client owner, the merchant client network address, the merchant client public key, the merchant client redirect_uri and the merchant client bank account information, and
the values of the payment server comprising the payment server name, the payment server public key, the payment server network address and the payment server APIs to exchange protocol related requests.

11. The method according to claim 9, the trusted relationship comprises a network level security and is established by:
exchanging messages between the payment server and the merchant client using a private key;
placing tokens within a JSON web token container; and
applying mutual SSL for communications after the merchant client is registered with the payment server.

12. The method according to claim 8, further comprising denying the transfer of the payment to the merchant client by the payment server when the first client fails to authorize the payment and exiting the online transaction without payment.

13. The method according to claim 8, further comprising:
when the credentials are validated by the payment server,
issuing a temporary code to the merchant client by the payment server;
receiving the first token at the payment server in exchange for the issued temporary code from the merchant client;
when the first client authorizes sending of the profile information, issuing the first token and the second token to the merchant client by the payment server, the second token comprising the profile information; and
when the first client fails to authorize the sending of the profile information, issuing the first token to the merchant client, by the payment server, without providing the profile information.

14. The method according to claim 13, wherein the transmitting payment by the payment server comprises
receiving a status of the payment using the first token, the status identifying whether the scope of the payment token has expired;
granting the payment to the merchant client when the scope of the first token has not expired;
receiving a payment execution transaction from the merchant client when the payment has been granted, after the profile information has been verified; and
paying the merchant client the payment in the amount associated with the online transaction, and confirming payment.

15. The method according to claim 8, wherein payment to the merchant client is processed after the merchant client confirms shipment of an item purchased during the online transaction.

16. The method according to claim 8, wherein the profile information comprises the first client name, shipping address, billing address and contact information.

17. The method according to claim 14, wherein the scope of the payment token is defined as expiring after one execution of payment.

18. A computer program product comprising:
a computer readable storage medium having computer readable program code embodied therewith, the computer readable program code comprising:
computer readable program code configured to authenticate a client at a website of a payment processor, the payment processor associated with a financial institution of the client and storing client credentials and access restriction data, and receive login credentials from the client to verify a payment associated with an online transaction made on a merchant website, the client being transparently redirected to the website of the payment processor;
computer readable program code configured to authorize the payment to a financial institution associated with the merchant website using a first token to grant access to the financial institution of the merchant website and provide a scope of the payment, after the client credentials read from and validated by the payment processor;
computer readable program code configured to establish a trusted relationship between the financial institution of the payment processor and the financial institution of the merchant website using the first token;
computer readable program code configured to provide a mutually secure connection between the financial institution of the payment processor and the financial institution of the merchant website after establishing the trusted relationship; and
computer readable program code configured to remit the payment to a financial institution of the merchant website upon completion of the online transaction by the client, and restricting access of payment details to the merchant website or the financial institution of the merchant website based on rules governing the access restriction data.

19. The computer program product according to claim 18, wherein
the computer readable program code is configured to receive a registration request at the payment processor to register the merchant website with the payment processor; and
the computer readable program code is configured to provide values to the merchant website in response to the registration.

20. The computer program product according to claim 19, wherein the trusted relationship comprises a network level security that is established by:
the computer readable program code configured to exchange messages between the payment processor and the merchant website using a private key;
the computer readable program code configured to place tokens within a JSON web token container; and
the computer readable program code configured to apply mutual SSL for communications after the merchant website is registered with the payment processor.

21. The computer program product according to claim 18, wherein the computer readable program code is configured to deny the transfer of the payment to the merchant website by the payment processor when the client fails to authorize the payment and exit the online transaction without payment.

22. The computer program product according to claim 18, wherein the computer readable program code is configured to:
when the credentials are validated by the payment processor,
issue a temporary code to the merchant website by the payment processor;
receive the first token at the payment processor in exchange for the issued temporary code from the merchant website;
when the client authorizes sending of the profile information, issue the first token and the second token to the merchant website by the payment processor, the second token comprising the profile information; and
when the client fails to authorize the sending of the profile information, issue the first token to the merchant website, by the payment processor, without providing the profile information.

23. The computer program product according to claim 22, wherein when payment is remitted
the computer readable program code is configured to receive a status of the payment using the first token, the status identifying whether the scope of the payment token has expired;
the computer readable program code is configured to grant the payment to the merchant website when the scope of the first token has not expired;
the computer readable program code is configured to receive a payment execution transaction from the merchant website when the payment has been granted, after the profile information has been verified; and
the computer readable program code is configured to pay the financial institution of the merchant website the payment in the amount associated with the online transaction, and confirming payment.

24. The computer program product according to claim 18, wherein payment to the financial institution of the merchant website is processed after the merchant website confirms shipment of an item purchased during the online transaction.

25. The computer program product according to claim 22, wherein the scope of the payment token is defined as expiring after one execution of payment.
